(19) United States
(12) Patent Application Publication
(10) Pub. No.: US 2010/0283665 A1
(43) Pub. Date: Nov. 11, 2010

(54) Mitigation of RF Oscillator Pulling through Adjustable Phase Shifting

(76) Inventors: Imran Bashir, McKinney, TX (US); Robert Bogdan Staszewski, Garland, TX (US); Oren Eliezer, Plano, TX (US); Meng-Chang Lee, Allen, TX (US)

Correspondence Address: TEXAS INSTRUMENTS INCORPORATED, P O BOX 655474, M/S 3999, DALLAS, TX, 75265, US

(21) Appl. No.: 12/435,405

(22) Filed: May 5, 2009

(51) Int. Cl. G01S 7/40; H04M 1/00

(52) U.S. Cl. 342/174; 455/571

(57) ABSTRACT

A digitally controlled mechanism for the minimization of the self-interference caused by an amplitude modulated signal generated within a polar transmitter to the oscillator circuit, where the carrier of that transmitter is created. A digitally controlled delay between the circuit where the signal is generated and the circuit where it is amplitude-modulated allows adjustment of the delay or phase-shift between the aggressing and victim signals. The optimal delay that is to be introduced in the path is determined, and a corresponding control word is generated to arrive at the selected delay/phase-shift.

### FIELD OF THE INVENTION

This invention generally relates to the field of radio frequency transmitters and data communications. In particular, it relates to cellular telephony and communication devices such as Bluetooth, WLAN, and cellular transceivers using digitally-intensive radio frequency (RF) circuitry.

### BACKGROUND OF THE INVENTION

Wireless cellular communication networks incorporate large numbers of mobile user equipment (UEs) and a number of base nodes (NodeBs). A NodeB is generally a fixed station, and may also be called a base transceiver system (BTS), an access point (AP), a base station (BS), or some other equivalent terminology. As improvements of networks are made, the NodeB functionality evolves, so a NodeB is sometimes also referred to as an evolved NodeB (eNB). In general, NodeB hardware, when deployed, is fixed and stationary, while the UE hardware is typically portable. In contrast to NodeB, the mobile UE can comprise portable hardware.

User equipment (UE), also commonly referred to as a terminal or a mobile station, may be fixed or mobile device and may be a wireless device, a cellular phone, a personal digital assistant (PDA), a wireless modem card, and so on. Uplink communication (UL) refers to a communication from the mobile UE to the NodeB, whereas downlink (DL) refers to communication from the NodeB to the mobile UE. Each NodeB contains the radio frequency transmitter(s) and receiver(s) used to communicate directly with the mobiles, which move freely around it. Similarly, each mobile UE contains the radio frequency transmitter(s) and receiver(s) used to communicate directly with the NodeB. In cellular networks, the mobiles cannot communicate directly with each other but have to communicate with the NodeB.

With each successive cellular phone handset generation, users demand more features in a smaller form factor. Some recent examples include cell phones with integrated Bluetooth, GPS, digital camera, and MP3 functionality. Process shrinks help deliver a cost and size advantage for digital designs with relative ease. However, for analog/RF designs, the immaturity of advanced processes comes with design challenges that may outweigh the intended advantage. In older generation handsets, 30% to 40% of handset board space is occupied by analog/RF functionality which cannot be re-designed or migrated to the newer process/technology nodes easily, inhibiting vendor ability to cost effectively add features and reduce footprint.

Digital radio has recently allowed the replacement of space consuming analog RF circuitry with much more compact digital circuitry, thereby facilitating the ability to port designs rapidly to more advanced lithographies. Texas Instruments (TI) has proven this concept with its Digital RF Processor (DRP™) architecture, which it has successfully implemented in production versions of its Bluetooth BRF6xxx transceivers, GSM/GPRS LoCosto TCS23xx transceivers among other chips. DRP implementation is consistent with the ongoing trend toward RF-CMOS in the cellular area, making it attractive in terms of power consumption, cost, and the integration of multiple radios.

Oscillators are a key component in the design of radio frequency (RF) communication systems. The estimation and calibration of the modulation gain of an RF oscillator is currently an area of active research. Accurate knowledge of this gain significantly reduces the complexity and enhances the performance of the phase-locked loop (PLL) as well as the transmit frequency-modulation path. It is particularly beneficial in systems implemented in deep submicron and nanoscale CMOS and based on frequency/phase and amplitude (i.e., polar) topology. Estimation of RF oscillator frequency-modulation gain is especially important in low-cost dominantly-digital or digitally-intensive high-volume transceivers. In such systems, the phase locked loop sets the loop bandwidth while the transmitter sets the transfer function of the direct frequency modulation path wherein the acceptable gain estimation error ranges from less than 1% for LTE/WCDMA to several percents for EDGE (Enhanced Data rates for GSM Evolution), GSM and Bluetooth, for example.

EDGE transmitters, as well as other non-constant amplitude transmitters, may be affected by modulation distortion due to the RF oscillator pulling by the transmitted RF output and supply-ground coupling of extraneous noise sources. Whether using a polar or I/Q TX modulator, the instantaneous transmitted frequency at the SoC (system on a chip) output or PA (power amplifier) output, or a harmonic of it, are either close or equal to the resonant frequency of the RF oscillator, thus creating a frequency puling force. Various mechanisms exist through which such pulling can occur. For example, the aggressing signal may cause capacitance changes in the resonance circuit that correspond to the amplitude fluctuations in it, thereby creating parasitic frequency modulation. Additionally, supply-ground coupling of current generated by the transmitter's amplitude modulation circuitry integrated on the same die causes frequency pushing of the oscillator.

In a typical EDGE transmitter, amplitude modulation in the pre-power amplifier (PPA) causes frequency pulling of the DCO, thus leading to performance degradation in both error-vector-magnitude (EVM) and modulation spectrum. The pulling problem is currently solved in industry by (1) significantly increasing the loop bandwidth, thereby allowing sufficient suppression for the phase/frequency perturbations induced onto the RF oscillator, and by (2) using an offset PLL architecture that is based on non-harmonic frequency planning, such that the amplitude modulated signal in the PPA is not harmonically related with the oscillator's frequency and cannot aggress it. Both of these methods significantly increase the hardware complexity and the power consumption.

Previous work addressing this problem has also focused on fixing the root cause, i.e., determining the aggressor and the coupling mechanism and then attempting to mitigate one or both of them. The work done in “Study of the different coupling mechanisms between a 4 GHz PPA and a 5-7 GHz LC-VCO,” (IEEE Radio Frequency Integrated Circuits Symposium, Session RTU3A, no. 3, pp. 475-478, June 2008) focuses on three different sources of coupling between the PPA and the oscillator: resistive (substrate), magnetic (between inductors and bond wires), capacitive (between interconnects). Unlike most of the RF-friendly processes, CMOS does not offer significant DC resistance between two circuits, i.e., the RF oscillator and the PPA or PA, the transistors of which are tied to the same substrate through the back gate. In the above publication, by dicing the die and creating an air gap of 30 μm, the coupling between the PPA and the oscillator was shown to be significantly reduced. The substrate was the most dominant coupling path according to this study. The second dominant path was found to be the magnetic coupling between the LC tank of the oscillator and the inductor tied to the drain of the PPA. By increasing the distance between the two circuits (after the dicing process), the mutual inductance between the inductors and the coupling magnitude was reduced notably. This publication did not mention the contribution of the bondwire coupling exclusively but accepted that it also had a role in the coupling mechanism. The third type of coupling is capacitive and is usually less dominant unless the PPA and oscillator output wires are routed next to each other. The work published in “5.8 GHz ETC SiGe-MMIC Transceiver having Improved PA-VCO Isolation with Thin Silicon Substrate,” (Microwave Symposium Digest 2006. IEEE MTT-S International, pp. 2039-2042, June 2006) claims that the isolation between the oscillator and PA can be increased by thinning the substrate.

### BRIEF DESCRIPTION OF THE DRAWINGS

Particular embodiments in accordance with the invention will now be described, by way of example only, and with reference to the accompanying drawings:

FIG. 1 is a pictorial of an illustrative telecommunications network that employs an embodiment of digitally controlled delay in transceivers used in the network;

FIG. 2 is a block diagram of a single-chip radio with an all-digital local oscillator and transmitter with an embodiment of digitally controlled delay and a discrete-time receiver;

FIG. 3 is a more detailed block diagram illustrating the all-digital phase locked loop (ADPLL) based polar transmitter of FIG. 2 constructed in accordance with the present invention;

FIG. 4 is a block diagram that illustrates an embodiment of a digitally controlled delay between an oscillator and a pre-power amplifier (PPA) in more detail;

FIG. 5 is a plot illustrating how amplitude modulation is performed by the PPA of FIG. 4;

FIG. 6 is a more detailed diagram of the core of a digitally controlled oscillator (DCO);

FIG. 7 illustrates the tracking bank varactors used by the DCO of FIG. 6;

FIG. 8 is a plot that illustrates pulling effects on the DCO of FIG. 6;

FIG. 9 is a plot that illustrates error vector magnitude vs. PPA output power over various temperatures;

FIGS. 10A-10E illustrate a hypothetical coupling mechanism between the PPA and DCO;

FIG. 11 is a block diagram of an embodiment of a digitally controlled delay module;

FIG. 12 is a plot illustrating variance in a phase error signal versus delay for different transmitted bursts;

FIG. 13 is a block diagram of a pulling mechanism in a GSM radio that may be mitigated using a digitally controlled delay module; and

FIG. 14 is a block diagram of a digital system with an embodiment of a digitally controlled delay for mitigation of oscillator pulling within a digital radio transceiver.

### DETAILED DESCRIPTION OF EMBODIMENTS OF THE INVENTION

Embodiments of the present invention provide for mitigation of frequency-pulling of a digitally controlled oscillator (DCO) due to pre-power amplifier (PPA) activity. An adjustable phase delay is provided between the DCO and the PPA. In one embodiment, the adjustable phase delay is provided through a chain of inverters. The delay may be calibrated using a phase error (PHE) signal from a phase detector in a phase locked loop (PLL) that forms the DCO. The PHE reflects the extent of parasitic modulation suffered by the DCO as a result of pulling; hence the variance of this signal, as well as other properties of it extracted through appropriate processing, can be used to sense the extent of pulling and calibrate for optimum delay. In one embodiment, this delay is calibrated in the center of the Digital Cellular System (DCS1800) and Personal Cellular System (PCS1900) bands. Frequency-dependent fine-tuning of the delay, referred to as frequency compensation, can be based on the computed distance between the frequency of operation and the frequency used for calibration, as the optimal delay would linearly depend on the frequency due to the phase shift for a given delay being given by: θ=2πfτ, where θ represents the phase shift, f represents the frequency, and τ represents the delay. Temperature compensation, to account for the dependency of the circuit's delay upon the temperature, can be performed according to a well characterized empirical formula.

Embodiments of the invention in a radio may be required to conform to 3GPP (Third Generation Partnership Project) specifications for GSM Global System for Mobile Communications) and EDGE (Enhanced Data rates for GSM Evolution) standards. While GSM is based on GMSK (Gaussian Minimum Shift Keying), a constant envelope modulation, EDGE requires controlled amplitude modulation at the transmitter output. The activity in the PPA as it modulates the amplitude of the RF signal will cause the DCO to suffer amplitude-dependent parasitic frequency modulation on top of the FM due to data. The extent of parasitic modulation may be a function of various factors, including the signal level, and it degrades the modulation accuracy of the transmitter measured as EVM (error vector magnitude) and spectral mask. The output power range specification for an exemplary embodiment in a Digital Radio Processor for EDGE (DRPe) transceiver is from −30 dBm to −2 dBm.

To aid in understanding the principles of the present invention, a description is provided in the context of a digital RF processor (DRP) transmitter and receiver that may be adapted to comply with a particular wireless communications standard such as GSM, Bluetooth, WCDMA (Wideband Code Division Multiple Access), etc. It is appreciated, however, that the invention is not limited to use with any particular communication standard and may be used in control, optical, wired and wireless applications. Further, the invention is not limited to use with a specific modulation scheme but is applicable to any modulation scheme including both digital and analog modulation.

Note that throughout this document, the term communications device is defined as any apparatus or mechanism adapted to transmit, or transmit and receive data through a medium. The communications device may be adapted to communicate over any suitable medium such as RF, wireless, infrared, optical, wired, microwave, etc. In the case of wireless communications, the communications device may comprise an RF transmitter, RF receiver, RF transceiver or any combination thereof. The notation DRP is intended to denote either a Digital RF Processor or Digital Radio Processor. References to a Digital RF Processor infer a reference to a Digital Radio Processor and vice versa.

A key component of an exemplary embodiment of a transmitter is a digitally controlled oscillator (DCO) that is part of an interpolated all-digital phase-locked loop (ADPLL). The DCO avoids any analog tuning controls. The DCO generates a high-quality base-station-synchronized frequency reference such that the transmitted carrier frequencies and the received symbol rates are accurate to within 0.1 ppm. Note that the specific control (digital or analog) of the RF oscillator (DCO or VCO, respectively) is not critical to the disclosed principles of operation.

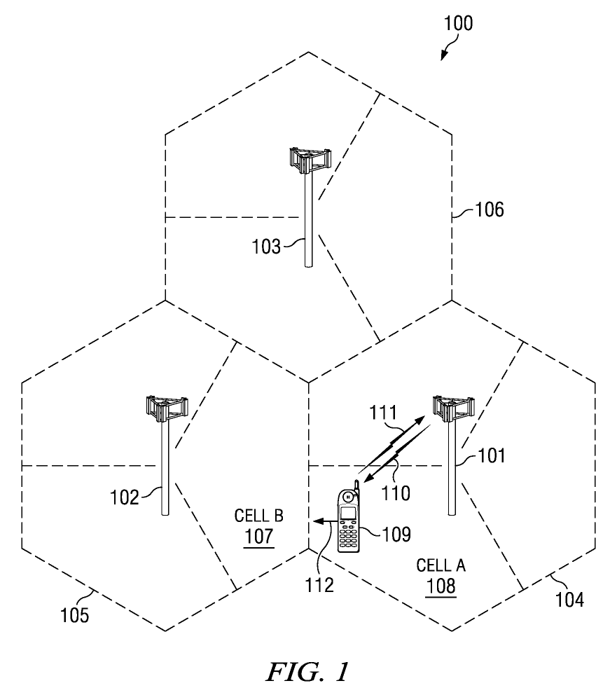

FIG. 1 shows an exemplary wireless telecommunications network 100. The illustrative telecommunications network includes representative base stations 101, 102, and 103; however, a telecommunications network necessarily includes many more base stations. Each of base stations 101, 102, and 103 are operable over corresponding cell areas 104, 105, and 106. Each base station's coverage area may be further divided. In the illustrated network, each base station's coverage area is divided into three cell areas. Handset or other UE 109 is shown in cell area A 108, which is within cell 104 of base station 101. Base station 101 is transmitting to and receiving transmissions from UE 109 via downlink 110 and uplink 111. As UE 109 moves out of cell area A 108, and into cell area B 107, UE 109 may be handed over to base station 102. A UE in a cell may be stationary such as within a home or office, or may be moving while a user is walking or riding in a vehicle. UE 109 moves within cell 108 with a velocity 112 relative to base station 102.

In one embodiment, UE 109 is transmitting to and receiving from base station 101 voice and/or data transmissions. As the UE is transmitting, various transmission symbols will have different amplitudes which will cause different amounts of power to be required in the pre-power amplifier of the transmitter. As discussed earlier, these power shifts tend to additionally exacerbate frequency pulling of the DCO. As discussed above, the present embodiment of the transceiver minimizes pulling by delaying the output of the DCO by a slight amount prior to being amplitude modulated in the pre-power amplifier, as will be explained in more detail below.

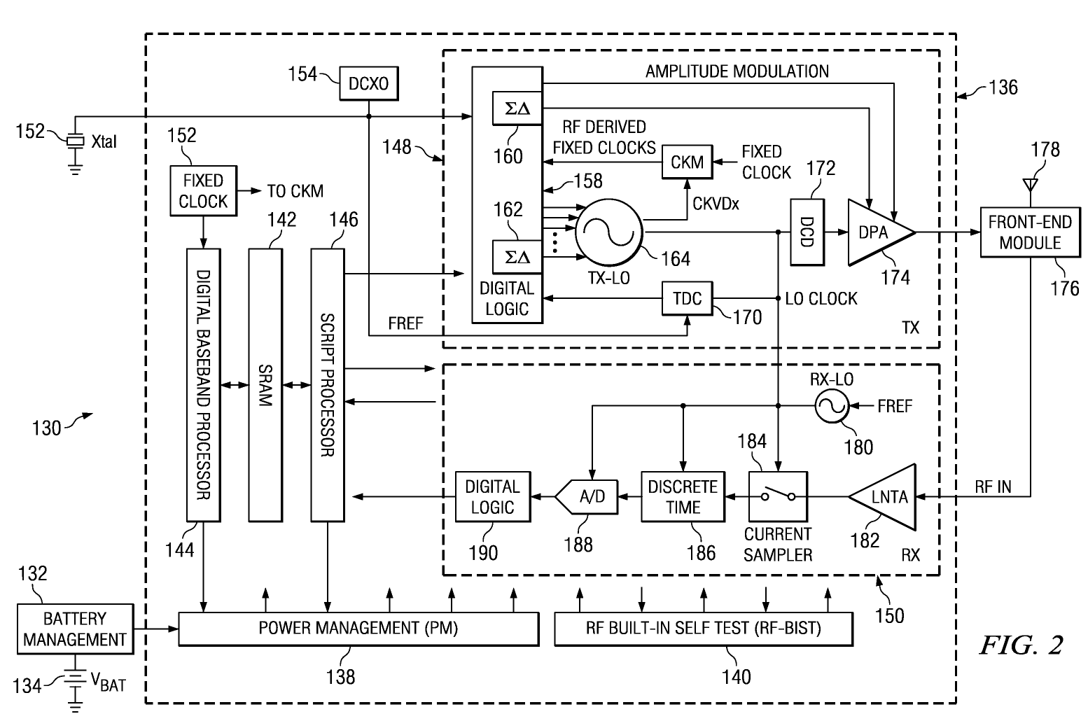

A block diagram illustrating a single chip radio incorporating an all-digital local oscillator based polar transmitter and digitally-intensive receiver is shown in FIG. 2. For illustration purposes only, the transmitter, as shown, is adapted for the GSM/EDGE/WCDMA cellular standards. It is appreciated, however, that one skilled in the communication arts can adapt the transmitter illustrated herein to other modulations and communication standards as well without departing from the spirit and scope of the present invention. This embodiment of a DRP for UMTS (Universal Mobile Telecommunication System) is a Digital RF Processor (DRP)-based dominantly digital transceiver integrated with a digital baseband processor in 65 nm or 45 nm CMOS technology. This DRP EDGE/WCDMA (2.5G/3G) transmitter (TX) uses a polar transmission architecture, wherein the instantaneous frequency of the aggressing signal (typically at a harmonic of the output signal rather than at its fundamental frequency) is equal to that of the victim RF oscillator at every instance, allowing a fixed phase relationship to be defined between these signals. Such relationship does not exist in transmitters operating in Cartesian or I/Q coordinates, where the local-oscillator generating the carrier frequency (or a harmonic of it) is typically not modulated and the mixing created by the I/Q baseband signals creates instantaneous frequency deviations between the aggressing signal at the output of the transmitter and the oscillator's frequency.

The radio circuit, generally referenced 130, comprises a radio integrated circuit 136 coupled to a crystal 152, antenna front end module 176 connected to antenna 178 and battery management circuit 132 with battery 134. The radio chip 136 comprises a script processor 146, digital baseband (DBB) processor 144, memory 142 (e.g., static RAM), transmit (TX) block 148, receiver (RX) block 150, digitally controlled crystal oscillator (DCXO) 154, power management unit 138, RF built-in self test (BIST) 140. Battery 134 and battery management circuit 132 are connected to radio chip 136 for providing power. The TX block comprises high speed and low speed digital logic block 158 including sigma-delta (ΣΔ) modulators 160, 162, digitally controlled oscillator (DCO) 164, digitally controlled pre-power amplifier (PPA) or power amplifier (DPA) 174, and time-to-digital converter (TDC) circuit 170. The transmitter generates various radio frequency signals, as defined by the 3GPP specifications. For example, the transmitter may support one or more of the 3G UMTS frequencies: 850, 900, 1700, 1900, or 2100 MHz.

A key component of transmitter block 148 is digitally controlled oscillator (DCO) 164. DCO 164 avoids any analog tuning controls. The DCO generates a high-quality base station-synchronized frequency reference such that the transmitted carrier frequencies and the received symbol rates are accurate to within 0.1 ppm. Fine frequency resolution is achieved through high-speed sigma-delta (ΣΔ) dithering of its varactors. Digital logic built around the DCO realizes an interpolated all-digital PLL (ADPLL) that is used as a local oscillator for both the transmitter and receiver. The polar transmitter architecture utilizes the wideband direct frequency modulation capability of the ADPLL and a digitally controlled power amplifier (DPA) 174 for the amplitude modulation. The DPA operates similarly to class-E mode, whereby each transistor is either turned on or off, and uses an array of nMOS transistor switches to regulate the RF amplitude and acts as a digital-to-RF amplitude converter (DRAC). It is followed by a matching network and an external antenna front-end module 176, which comprises a power amplifier (PA), a transmit/receive switch for the common antenna 178 and RX surface acoustic wave (SAW) filters. Fine amplitude resolution is achieved through high-speed ΣΔ dithering of the DPA NMOS transistors.

The transmitter comprises a polar architecture in which the amplitude and phase/frequency modulations are implemented in separate paths. Transmitted symbols generated in the digital baseband (DBB) processor are first pulse-shape filtered in the Cartesian coordinate system. The filtered in-phase (I) and quadrature (Q) samples are then converted through a COordinate Rotation Digital Computer (CORDIC) algorithm into amplitude and phase samples of the polar coordinate system. The phase is then differentiated to obtain frequency deviation. The polar signals are subsequently conditioned through signal processing to sufficiently increase the sampling rate in order to reduce the quantization noise density and lessen the effects of the modulating spectrum replicas.

As will be described in more detail below, a digitally controlled delay (DCD) 172 is located between oscillator 164 and DPA 174 to provide for mitigation of frequency-pulling of the oscillator due to power amplifier activity. A phase error signal formed within logic block 158 as part of the phase locked loop operation is used to perform calibration of the DCD, as will be described in more detail below. Since the phase error signal is a digital signal, it can be directly accessed and processed by script processor 146 for calibration purposes.

The receiver employs a discrete-time architecture in which the RF signal is directly sampled and processed using analog and digital signal processing techniques. RX block 150 comprises a low noise transconductance amplifier 182, current sampler 184, discrete time processing block 186, analog to digital converter (ADC) 188 and digital logic block 190. The receiver 150 employs a discrete-time architecture in which the RF signal is directly sampled at the Nyquist rate of the RF carrier and processed using analog and digital signal processing techniques. The transceiver is integrated with a script processor 146, dedicated digital base band processor 144 (i.e. ARM family processor and DSP) and SRAM memory 142. The script processor handles various TX and RX calibration, compensation, sequencing and lower-rate data path tasks and encapsulates the transceiver complexity in order to present a much simpler software programming model. In this embodiment, a separate receiver local oscillator 180 is illustrated. It may be a simple phase locked loop referenced to DCXO 154, as illustrated, or there may be a separate band output within the ADPLL that forms the transmitter local oscillator 164.

The frequency reference (FREF) is generated on-chip by a 38.4 MHz (but could be 26.0 MHz or another frequency in another embodiment) digitally controlled crystal oscillator (DCXO) 154 coupled to TDC 170. An integrated power management (PM) system is connected to an external battery management circuit 132 that conditions and stabilizes the supply voltage. The PM comprises a switched mode power supply (SMPS) as well as multiple low drop out (LDO) regulators that provide internal supply voltages and also isolate supply noise between circuits, especially protecting the DCO. The SMPS is used for efficient conversion of the battery voltage to a level that can be used by on-chip LDOs. The RF built-in self-test (RFBIST) 140 performs autonomous phase noise and modulation distortion testing, various loopback configurations for bit-error rate measurements and implements various DPA calibration and BIST procedures. In this embodiment, the transceiver is integrated with the digital baseband, script processor and SRAM memory in a complete system-on-chip (SoC) solution. In other embodiments, the transceiver may be implemented on a different integrated circuit from the processors and SRAM.

Almost all the clocks on this SoC are derived from and are synchronous to the RF oscillator clock. This helps to reduce susceptibility to the noise generated through clocking of the massive digital logic. A fixed clock module 152 provides a buffered fixed clock signal that provides timing for DBB 144, script processor 146, SRAM 142 and other functional logic. In other embodiments, the fixed clock could be derived from the variable RF oscillator clock CLKVx, or from another independent clock source.

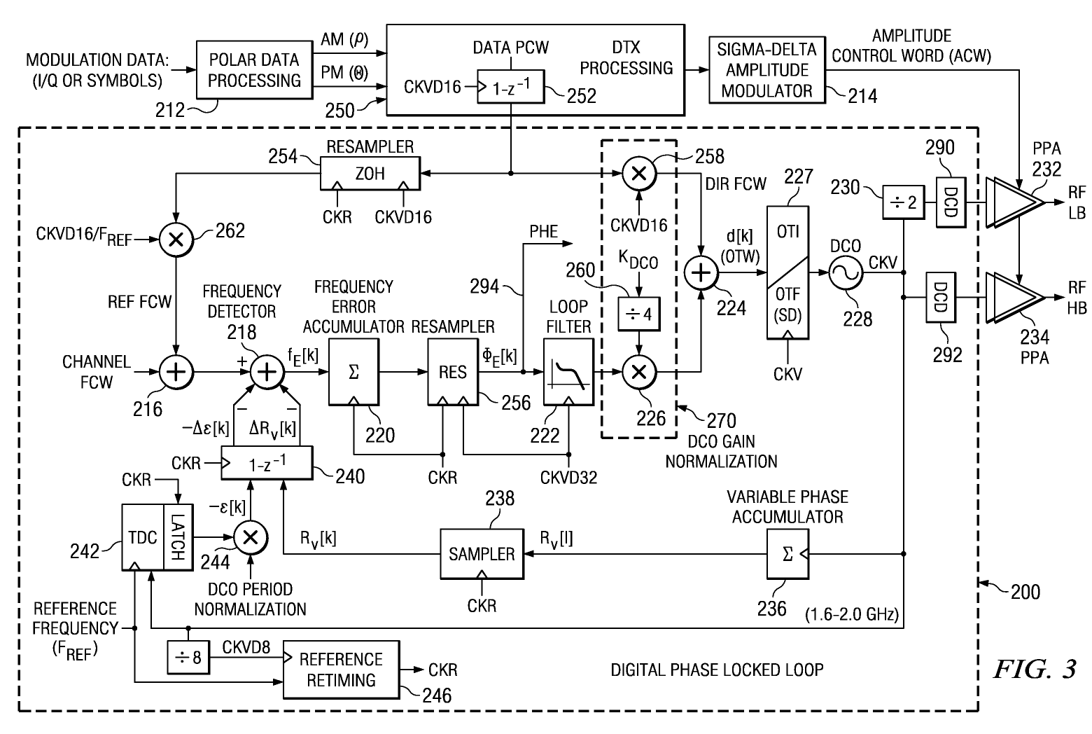

FIG. 3 is a more detailed block diagram of an ADPLL 200 used in the transceiver of FIG. 2 and constructed in accordance with the present invention. For illustration purposes only, the transmitter of the present embodiment is adapted for the GSM/EDGE cellular standard. It is appreciated, however, that one skilled in the communication arts can adapt the transmitter illustrated herein to other modulations and communication standards as well without departing from the spirit and scope of the present invention. For example, the transmitter illustrated in FIG. 3 can be extended for performing an arbitrary quadrature modulation scheme.

Portions of the ADPLL that are relevant to embodiments of the present invention are also described herein. This advanced all-digital frequency synthesizer possesses two-point digital, i.e., reference and direct, frequency modulation capability. ADPLL uses digital signal processing and efficient circuit design techniques. A 4 or 8 GHz digitally-controlled oscillator (DCO) 228 is at the heart of ADPLL, where fine frequency resolution is achieved through high-speed sigma-delta (ΣΔ) dithering 227. This setup allows for ADPLL loop control circuitry to be implemented in a fully digital manner using Infinite Impulse Response (IIR) filters 222 and a digital Proportional-integral (PI) controller. For the feedback of DCO phase in the time-domain, very fine time resolution (˜20 ps) is achieved by employing a Time-to-Digital Converter (TDC) 242 comprising a chain of digital inverters.

The ADPLL architecture is distinct in that the loop filter and bulk of the logic operates on an RF derived variable clock domain. Due to the common RF based clock source for the major digital components, convenient digital handoff is achieved in the signal paths. The architecture uses two resamplers 254, 256 (one linear and the other a simple zero-order hold) for the exchange of data from and to the reference clock domain to the variable RF clock domain. In the variable clock domain, availability of several edge-aligned clock domains also facilitate physical register transfer logic (RTL) hardware sharing by time slicing. ADPLL can be embodied by more than one arrangement of the resampler and the other digital blocks. While an exemplary embodiment is described herein, this description is not intended to be limiting.

The core of the ADPLL is a digitally controlled oscillator (DCO) 228 adapted to generate the RF oscillator clock CKV. The oscillator core (not shown) operates at twice the 1.6-2.0 GHz high frequency band or four times the 0.8-1.0 GHz low frequency band. The output of the DCO is then divided for precise generation of RX quadrature signals, and for use as the transmitter's carrier frequency. For GSM/EDGE transceivers, a single DCO is shared between transmitter and receiver and is used for both the high frequency bands (HB) and the low frequency bands (LB). However, for modern 3G (WCDMA) or other duplex transmission systems, separate local oscillators might be needed to supply TX and RX carrier frequencies.

DCO 228 comprises tunable switchable varactor elements, cross-coupled pairs of NMOS transistors, and a biasing circuit. The DCO varactors may be realized as n-poly/n-well MOS capacitor (MOSCAP) devices that operate in the flat regions of their C-V curves. Current advanced CMOS process lithography allows creation of extremely small-size but well-controlled varactors. The switchable capacitance of the finest differential TB varactor is in tens of attofarads. This resolution, however, is still too coarse for wireless applications and requires high-speed ΣΔ dithering to enhance the time-averaged frequency resolution. The output of the DCO is input to the RF high band pre-power amplifier 234. It is also input to the RF low band pre-power amplifier 232 after divide by two in divider 230.

As will be described in more detail below, a digitally controlled delay (DCD) 290 is located between divider 230 and PPA 232 for the low band. In this embodiment, a second DCD 292 is placed between DCO 228 and PPA 234 for the high band. In other embodiments, a second DCD may not be needed, or there may be only one band implemented.

In case of transmit modulation, the symbols, (for example GSM, EDGE, WCDMA, etc), in the form of in-phase and quadrature data streams are received from the digital baseband (DBB) circuit 144 in FIG. 2. The GSM symbols are passed through a pulse-shaping filter (PSF) within processor 212 that converts it to phase modulation. This phase modulation is interpolated in transmit data (DTX) processing circuit 250 and then passed on to the ADPLL after differentiation at the CKVD16 clock rate using differentiator 252. CKV is the ADPLL RF output digital variable-phase clock in case of high-bands (HB>1 GHz) or twice the RF output clock in case of low-band (LB<1 GHz).

For the case of EDGE, WCDMA, etc. the complex vector modulation I/Q (in-phase signal and quadrature signal) data streams are fed to a COordinate Rotation Digital Computer (CORDIC) within processor 212, which converts it from Cartesian to polar representation. The resulting amplitude modulation signal is passed through sigma-delta amplitude (SAM) signal processing blocks 214 before they are passed onto the on-chip digital pre-power amplifier (DPA) 234, while the phase modulation output of the cordic is passed onto the ADPLL after the necessary interpolation and signal processing, which performs the phase modulation of the DCO.

Under no modulation conditions, such as in receive mode, the ADPLL digitally controls the DCO to produce a stable clock (CKV) in the targeted RF frequency band. In the feedback path, CKV is used for phase detection and reference retiming. The time to digital phase conversion in the feedback happens using a TDC inverter chain 242.

The channel and data frequency control words are in the frequency command word (FCW) format, which is defined as the fractional frequency division ratio N, with a fine frequency resolution limited only by the FCW word-length. For example, with 24 fractional FCW bits, the frequency granularity using a 38.4 MHz reference frequency is 38.4 MHz/2²⁴≡2.29 Hz. In this embodiment, the direct point frequency injection is at the CKVD16 (which is 1×HB/2×LB channel frequency divided by 16, i.e., CKVD16=f_{V}/16) rate, so the possible DCO frequency resolution is in the range of 6˜7.5 Hz (computed as f_{V}/16/2²⁴)

The frequency reference (FREF) clock contains the only reference timing information for the RF frequency synthesizer to which phase and frequency of the RF output are to be synchronized. The RF output frequency (f_{V}) is related to the reference frequency f_{R} according to the following formula.

f_{V}=N·f_{R} (1)

where, N=f/f_{R}≡FCW.

### Synchronous Phase-Domain Operation

The ADPLL operates in a digitally-synchronous fixed-point phase domain. The variable phase R_{V}[i] is determined by counting the number of rising clock transitions of the DCO oscillator clock CKV using variable phase accumulator 236. The variable phase R_{V}[i] is sampled via sampler 238 to yield sampled FREF variable phase R_{V}[k], where k is the index of the FREF edge activity. The sampled FREF variable phase R_{V}[k] is fixed-point concatenated with the normalized time-to-digital converter (TDC) 242 output ε[k]. The TDC measures and quantizes the time differences between the frequency reference FREF and the DCO clock edges. The sampled differentiated (via block 240) variable phase is subtracted from the frequency command word (FCW) by a synchronous arithmetic phase detector 218. The reference phase R_{R}[k] is conceptually obtained by accumulating FCW with every cycle of the retimed frequency reference (FREF) clock input.

The frequency error f_{E}[k] samples are accumulated via the frequency error accumulator 220 to create the phase error φ_{E}[k] samples. The digital phase error φ_{E}[k] is filtered by a digital loop filter 222 and then normalized by the DCO gain normalization circuit 270 in order to correct the DCO phase/frequency in a negative feedback manner. The loop behavior due to its digital nature is independent of process, voltage and temperature variations. The FREF retiming quantization error ε[k] is determined by the time-to-digital converter (TDC) 242 and the DCO period normalization multiplier 244. The TDC is built as a simple array of cascaded inverter delay elements and flip-flops, which produces time conversion resolution finer than 25 ps in the design process.

A phase error signal (PHE) 294 is used to perform calibration of the DCD, as will be described in more detail below. The PHE signal can be either the φ_{E}[k] error samples output by resampler 256, or it may be taken after filtering from loop filter 222. Since PHE signal 294 is a digital signal, it can be directly accessed and processed by script processor 146 for calibration purposes.

It must be recognized that the two clock domains, FREF and DCO, are not entirely synchronous and it is difficult to physically compare the two digital phase values without having to face meta-stability problems. During the frequency acquisition, their edge relationship is not known and during the phase lock the edges will exhibit rotation if the fractional FCW is non-zero. Consequently, the digital-word phase comparison is performed in the same clock domain. The synchronous operation is achieved by over-sampling the FREF clock using a higher-rate DCO derived clock (typically CKVD8) in reference retiming circuit 246. The resulting retimed CKR clock is thus stripped of the FREF timing information and is used throughout the system. This ensures that the massive digital logic is clocked after the quiet interval of the phase error detection by the TDC.

The main advantage of representing the phase information in fixed-point digital numbers is that, after the conversion, it cannot be further corrupted by noise. Consequently, the phase detector could be simply realized as an arithmetic subtractor that performs an exact digital operation. Thus, having a single conversion place, where the continuously-valued clock transition edge delay is quantized within the TDC, the susceptibility to noise and quantization errors is minimized and well controlled. It should be emphasized that it is very advantageous to operate in the phase domain for several reasons. First, the phase detector used is not a conventional correlative multiplier generating reference spurs. DRP architecture uses an arithmetic subtractor 218, which does not introduce any spurs into the loop. Second, the dynamic range of the phase error could be made arbitrarily large simply by the increasing word-length of the phase/frequency accumulators. Conventional three-state phase/frequency detectors are typically limited to only ±2π of the compare rate. Third, the phase domain operation is more amenable to digital implementations, contrary to the conventional approach.

### High-Speed Direct Frequency Modulation Capability

As shown in FIG. 3, the oscillating frequency deviation Δf is dynamically controlled by directly modulating the DCO frequency in a feed-forward manner. The ADPLL loop compensates by effectively removing the loop dynamics from the modulating transmit path (using the reference modulation injection). The remainder of the loop, including all error sources, operates under the normal closed-loop regime. This method is similar to the conventional two-point direct modulation scheme but because of the digital nature, it is exact and does not require any analog component matching, except for the DCO gain K_{DCO}=Δf/ΔOTW calibration, which is achieved in using a robust hybrid stochastic-gradient algorithm implemented in digital domain, where OTW is the oscillator tuning word and is analogous to the voltage tuning of a VCO.

The fixed-point frequency modulating data FCW is sampled in resampler 254 by the ADPLL DCO injection frequency f_{V}/16 and normalized in multiplier 262 to the value of ADPLL DCO injection frequency f_{V}/16. Through multiplier 258, using the direct injection of the normalized FCW directly at the DCO impacts the oscillating frequency. The PLL loop will try to correct this perceived frequency perturbation integrated over the update period of 1/f_{R}, which is then interpolated to the ADPLL operational frequency of f_{V}/32 in resampling interpolator 256. This corrective action is compensated by the other (compensating) reference feed that If the estimated DCO gain is accurate, i.e., \hat{K}_{DCO}≅K_{DCO}, then the loop response to the modulation is flat from dc to f_{V}/64 (or half of ADPLL operational frequency f_{V}/32). The immediate and direct DCO frequency control, made possible by accurate prediction of the DCO transfer function, is combined with the phase compensation of the PLL loop response. The two factors constitute the hybrid of predictive/closed PLL loop modulation method.

An advanced All-Digital PLL (ADPLL) frequency synthesizer is described in more detail in US Patent application 2008-0315960 to Waheed et al entitled “Digital Phase Locked Loop with Gear Shifting” which is incorporated by reference herein in its entirety.

### Oscillator Pulling

When it comes to integration of RF circuits with digital baseband in CMOS process, the designers are often faced with the unique challenge of minimizing parasitic coupling paths that can potentially deteriorate radio performance. The extent of performance degradation will depend on the nature of the aggressor and the robustness of the victim. The impact of the aggressor can vary depending on the application of the radio as well as the coupling path. In the embodiment of a DRP described in the preceding figures, the degradation in transmitter performance addressed by embodiments of the current invention is caused by AM-FM conversion within the DCO, which is the victim circuit, resulting from interference caused by the modulated signal within PPA, which is the aggressor. The objective of interference mitigation is to present a robust hardware solution assisted by a digital calibration and compensation scheme in order to minimize the effect of parasitic modulation over all the environmental and manufacturing corner conditions and to ensure the compliance of the transmitter's performance with the targeted specification. Before diving into discussion regarding the coupling mechanism, a more detailed description of the aggressor and the victim blocks is provided.

### The Aggressor: Pre-Power Amplifier (PPA)

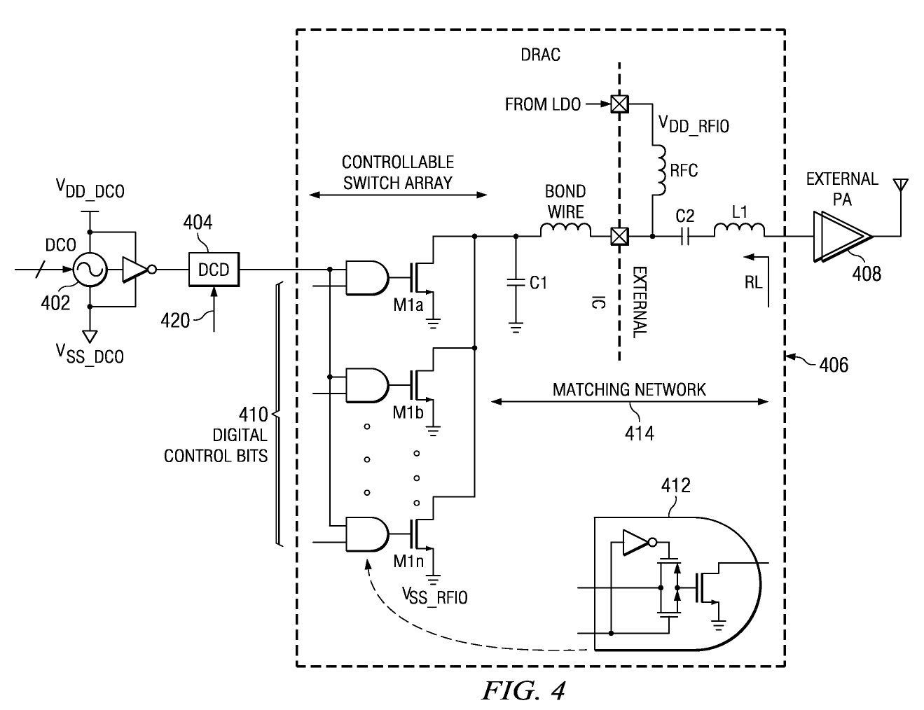

FIG. 4 is a block diagram that illustrates an embodiment of a digitally controlled delay 404 between an oscillator 402 and a pre-power amplifier (PPA) 406 in more detail. DCD 404 includes a control port 420 that may be a single signal line or signal bus. In this embodiment, control port 420 is coupled to script processor 146 of FIG. 2 and the amount of delay produced by DCD 404 may be configured by script processor 146, as will be described in more detail later.

Pre-power amplifier circuit 406 is essentially a Digital-to-RF Amplitude (DRAC) converter with a bank of NMOS transistors 410 enabled by the digital amplitude control word ACW as shown in FIG. 4. There are two different sizes of transistors in this circuit: 4× and 1× transistors, indicated generally as final-stage output transistors at 412. The 4x transistor has a step size of approximately 8 mV at low ACW codes and 1 mV at high ACW codes. There are a total of 256 4× transistors divided into four banks with 64 transistors in each bank. The 1× transistor is four times smaller in size and amplitude contribution compared to a 4× transistor. The drain terminals of all of these transistors are tied to a common node. The amplitude swing at the drain is proportional to the number of the transistors turned on. Matching network 414 provides filtering and impedance transformation from the PPA output to a 50-Ohm termination. The RFC inductor will cause the voltage swing at the drain to swing beyond the LDO supply of the PPA. The matching network is designed after extensive load-pull measurements that cover output power, peak to peak voltage at the drain (for reliability reasons), and output AM noise. There are a total of three 1× transistors used during amplitude modulation when fine resolution in amplitude is desired. An additional 1× transistor is dithered by the PPA sigma delta to further improve the amplitude resolution.

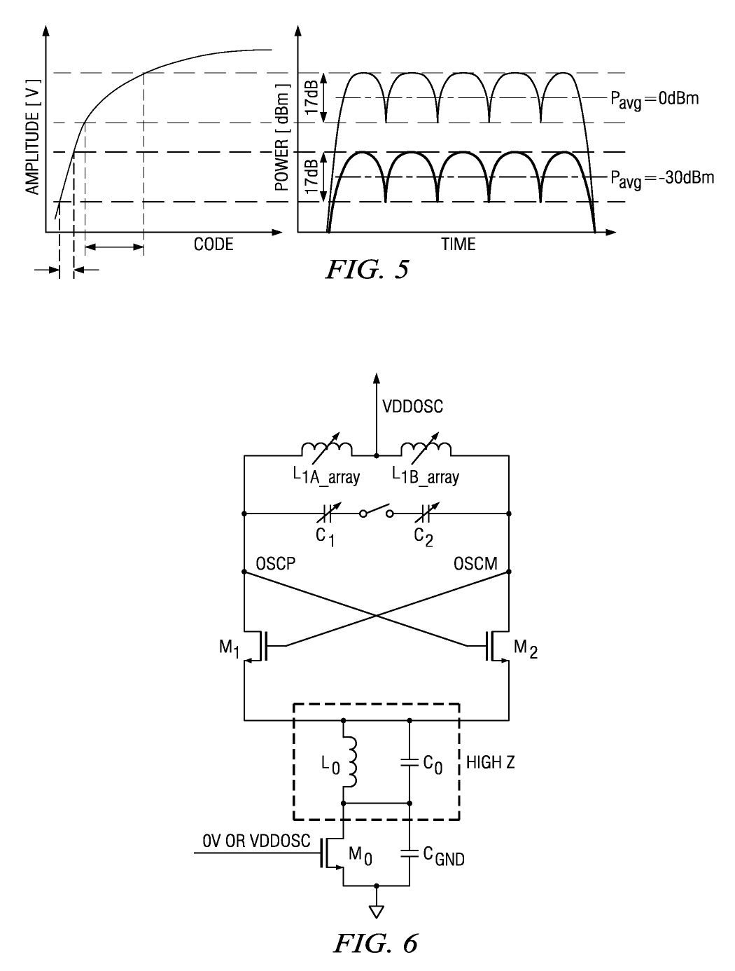

FIG. 5 illustrates how amplitude modulation is performed by the PPA at an average power of 0 dBm and −30 dBm. The predistortion of PPA amplitude and phase (not shown in the figure) is stored in memory and used during amplitude modulation. Depending on the desired average power level, the output of the predistortion logic selects the appropriate number of 4× and 1× transistors to perform a controlled amplitude modulation. The peak to peak power deviation specified by 3GPP for EDGE 8PSK modulation is 17 dB while the peak to average ratio is about 3 dB. It is evident from FIG. 5 that AM at high average power transmission will require switching of more 4× transistors compared to low average power transmission.

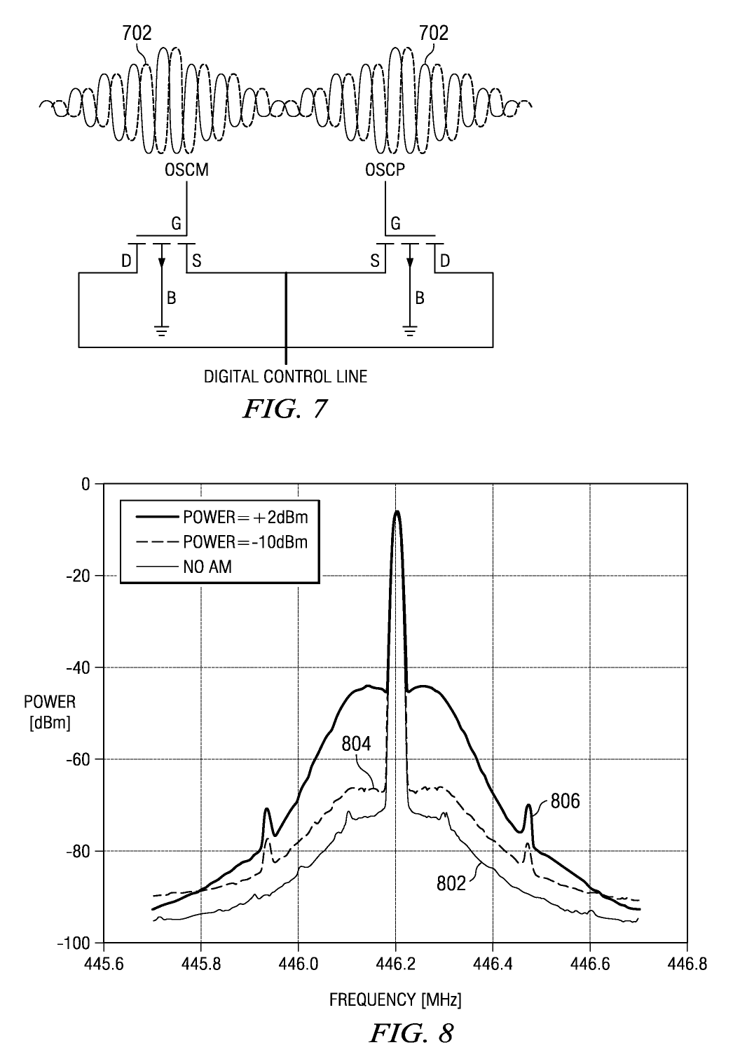

The design of DCO 402 is a cross coupled differential topology using NMOS transistors. A tail current source, shown in FIG. 6, controls the bias current and swing of the DCO amplitude. There are three different capacitor banks used for frequency tuning. The first one is called PVT Bank (PB) which has the largest gain KDCO and is designed using MIM (Metal-Insulator-Metal) capacitors. The other two are called Acquisition Bank (AB) and Tracking Bank (TB) that are designed with MOS varactors as illustrated in FIG. 7.

### Oscillator Pulling

In DRPe, an embodiment of the DRP transceiver targeting GSM/EDGE, the radio is required to conform to 3GPP specifications for GSM and EDGE standards. While GSM is based on GMSK, a constant envelope modulation, EDGE requires controlled amplitude modulation at the transmitter output. As discussed above, the amplitude modulation activity in the PPA causes the DCO to suffer parasitic modulation on top of the FM due to data. The extent of parasitic modulation degrades the modulation accuracy of the transmitter measured as EVM, as well as modulation spectrum. The output power range specification for the DRPe transceiver is from −30 dBm to −2 dBm. The DCO signal can be routed through an alternate path that goes through a frequency divider. This signal is not in the PPA path and hence is not amplitude modulated. However, the ADPLL control loop modulates the frequency of the DCO which makes this signal frequency-modulated. The FM on this signal can be turned off for test purposes by digital control in the modulator block. Once this signal is free from FM due to EDGE data, the extent of pulling suffered by the DCO while the PPA performs AM can be clearly seen by monitoring the spectrum of this signal, as shown in FIG. 8. FIG. 8 is a plot of clock signal CKVD4, which is a divide-by-4 version of the carrier CKV, when the carrier frequency is set to CKV=1785 MHz. In the absence of any parasitic modulation, the spectrum of the DCO signal would look like trace 802. With AM and average power beyond −10 dBm, the spectrum of the DCO degrades due to the effect of pulling, as illustrated by trace 804 for average power of −10 dBm and trace 806 for average power of 2 dBm. The result of this effect is degradation in modulation accuracy at the output of the transmitter, which in EDGE is measured in terms of Error Vector Magnitude or EVM.

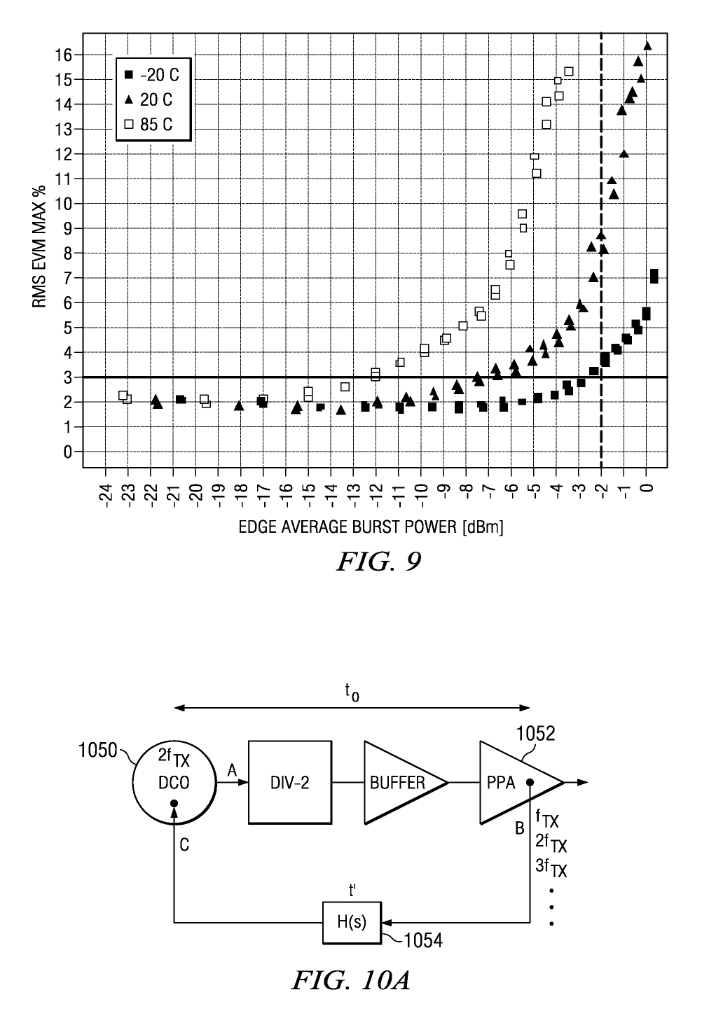

FIG. 9 is a plot that illustrates error vector magnitude vs. PPA output power over various temperatures. A similar set of plots can be produced that shows the EVM as a function of average output power across various process corners. An interesting observation is that not all process corners suffer from the same extent of pulling or degradation in EVM. The same is also true for temperature and transmitter frequency. Once the degradation due to temperature and process is determined, the adjustment of the configurable delay of DCD 404 can be compensated based on the current temperature of the DCO.

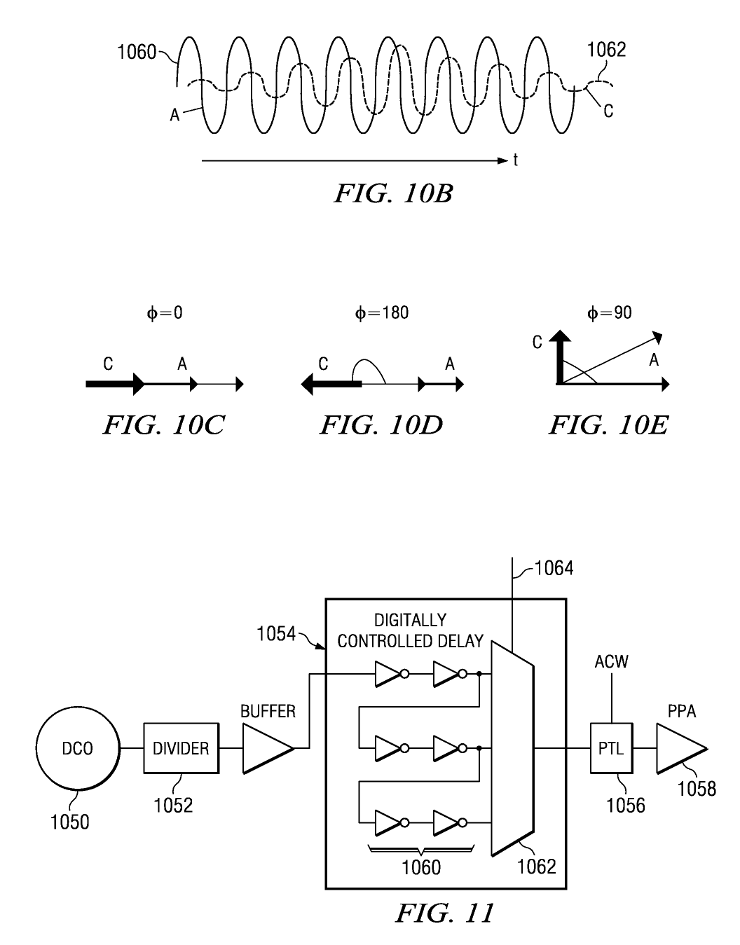

FIGS. 10A-10E illustrate a hypothetical coupling mechanism between the PPA and DCO. The model presents the PPA 1052 as the aggressor which produces frequency f_{TX} and its harmonics at node B. DCO 1050 is presented as the victim operating at frequency 2f_{TX} at node A which is represented waveform 1060 in FIG. 10B. The 2nd harmonic of the PPA output is at the same frequency as the DCO. This particular signal finds its way through the coupling path back to the DCO at node C. The time domain waveform at this node is represented by waveform 1062. The two signals at nodes A and C are at the same frequency but different phases. The difference in phase is in part due to the circuitry from the DCO to the PPA, the delay of which is denoted by to in FIG. 10A. The remaining phase difference comes from the delay in the return path from the PPA back to the DCO denoted by t′. The key to solving the problem is understanding key characteristics of transfer function H(s) 1054. It is the amplitude and phase of the signal at the critical node C and its relationship to the amplitude and phase of the signal at node A that can pull the DCO out of the intended phase trajectory during 8PSK modulation and thus degrade the EVM and modulated spectrum of the modulated carrier. As shown in FIGS. 10C-10E, the DCO signal at node A is disturbed by a signal returning from the PPA at the same frequency but different phase at node C. FIG. 10C illustrates a phase difference of 0°; FIG. 10D illustrates a phase difference of 180°, and FIG. 10E illustrates a phase difference of 90°.

The common conclusion from the investigations on DCO pulling is that the coupling path is between the PPA supply or ground, which is the aggressor node, and the DCO supply or ground, which is the victim node. At this point two possible theories will be presented as to what phase relationship between the aggressor and the victim minimizes the extent of parasitic modulation. ps A. DCO Pulling Due to Injection Locking to the Aggressor

This theory states that the root cause of pulling is injection locking of the DCO to the AM aggressor that penetrates into the LC tank and prevents the DCO from following the intended trajectory. The theory of pulling due to injection locking of the DCO is plausible but was determined not to be the root cause.

B. Pulling due to Sensitivity of Average Cₜₐₙₖ t0 DCO AM

A second theory states that the extent of damage due to pulling is maximum when the phase between the aggressor and the victim is 0° or 180°. To understand the reason behind this statement, one has to understand the DCO varactor design which is shown in FIG. 7. As this figure points out, the voltage on the gate of the MOS varactor is the DCO signal that has AM in presence of the aggressor, as illustrated in general at 702. The capacitance seen by the DCO through the gate is a function of the gate voltage. This means that in presence of a sinusoidal voltage at the gate, the DCO will see an average capacitance over the period of oscillation that would establish the DCO frequency. Therefore, for the DCO waveform, the average DCO frequency will be f1. When the DCO amplitude is increased slightly, the capacitance will start to rail on one end effecting the overall profile of the waveform. This asymmetry will change the average oscillation frequency to f2. Thus, AM on the DCO swing effectively gets converted to FM. The characteristics of this parasitic FM will be similar to the AM signal on the DCO signal which is essentially the same observation as the one shown in FIG. 8.

With this understanding of the mechanism of pulling, it is obvious that the worse case between the aggressor and the victim is either 0° and 180°, since the impact of the AM aggressing signal on the instantaneous amplitude of the DCO oscillations will be maximal at these two phases. The extent of the parasitic modulation will therefore be the worst at these angles, but would be minimal for the 90° phase difference. Any instantaneous deviation of the DCO's oscillation frequency from its intended value will create an error signal at the output of the phase detector in the ADPLL. If the disturbance is slow and spectrally confined within the loop bandwidth of the ADPLL, it will be effectively compensated by the loop response of the ADPLL in its effort to minimize the error signal at the phase detector output. This will ensure that the phase trajectory at the ADPLL output is maintained according to the modulation data presented to the ADPLL. There will be some finite period of time taken by the ADPLL to correct the frequency of the DCO, as it undergoes frequency perturbations due to the interference. If this time is significantly smaller than the data symbol period, the transmitter will perform properly in terms of modulation accuracy. However, such response time may imply a wide bandwidth for the PLL, which could result in an excessive level of noise passing form the reference oscillator and other sources to the output of the PLL, thus potentially failing other system requirements.

The nature of the problem in EDGE however is more complex. First, the architecture of the transmitter is polar, implying that the bandwidth of the FM and AM signals are wider than the composite EDGE spectrum itself. Therefore, the excursions in PPA power due to AM are sharp and short lived. The DCO suffers maximum interference during these excursions, and before the ADPLL can react to the accumulated error signal, the amplitude excursion is gone and the modulator continues to the next symbol. However, if the loop bandwidth is extended beyond the bandwidth of the excursion, the loop can react in time to bring the DCO back into the intended trajectory and maintain a proper EVM. While this may look like a good mitigation solution to pulling, there is a drawback. Widening the ADPLL loop bandwidth will degrade the phase noise of the ADPLL spectrum. When modulated with 8PSK data, close-in frequency offsets will be dominated by the modulation itself but the offsets above approximately 300-kHz will be dominated by the ADPLL phase noise. In this way, critical offsets such as 400-kHz from the channel, where the specification for spectrum mask is very critical, will be limited by the noise sources in the ADPLL. In case of DRPe, where the reference contribution is low due to the high reference frequency used by the ADPLL, the TDC quantization noise becomes the dominant contributor of phase noise at critical offsets

FIG. 11 is a block diagram of an embodiment of a digitally controlled delay module for mitigation of DCO pulling due to PPA activity. As mentioned earlier, the idea is to introduce an adjustable phase delay between DCO 1050 and PPA 1058 output through configurable delay module 1054. In this embodiment, DCD 1054 is a string of inverters 1060. A digitally controlled multiplexor 1062 selects from a number of tap points in the string of inverters. Control port 1064 is coupled to a control processor, such as script processor 146 of FIG. 2. The string of invertors is designed to provide a total delay that is greater than or equal to one quarter of a period of the aggressing RF signal. The number of tap points is selected to provide a coarse resolution of phase selection. The resolution of phase selection can be improved by increasing the number of inverter stages. The inverter elements are sized to minimize thermal noise contribution from the delay circuit.

Pass transistor logic 1056 performs the amplitude modulation as described in more detail with respect to FIG. 4. Divider 1052 is included in this embodiment, but other embodiments may be used that do not include a divider.

The delay is calibrated using PHE signal 294 (see FIG. 3) from the ADPLL. The PHE signal is sensitive to the extent of parasitic modulation suffered by the DCO as a result of pulling. Hence the variance of this signal can be used to sense the extent of pulling and calibrate for optimum delay. This delay will be calibrated in the center of DCS1800 and PCS1900 band. Compensation for temperature and process parameters will be performed according to a well characterized empirical formula.

During the calibration process, PHE signal 294 is sampled while the transceiver is set to transmit AM signal. The data from the DTX modulator block can either random or fixed sequence of bits. The signal is transmitted at high power and at the center frequency of the band over all possible delay settings. The delay resulting in the least variance in PHE will be stored in memory for compensation. Testing indicates that a constant value of delay setting maintains low EVM for a sizable bandwidth of 30 MHz. This may ease the burden on frequency compensation of the delay since it may not take too many inverters to compensate for the entire frequency band. Temperature compensation is done through a well characterized empirical formula.

The hardware portion of the solution is inexpensive since it does not require additional mask layers. The software portion of the solution involving calibration is expected to take less than 1 second and hence is as cost effective as the hardware itself. The idea is to establish, at least during the calibration, how much interference is being experienced through proper analysis of the PLL's error signal. This allows calibration to be done without relying on analysis of the transmitter's RF output signal, which would require additional hardware resources on-chip.

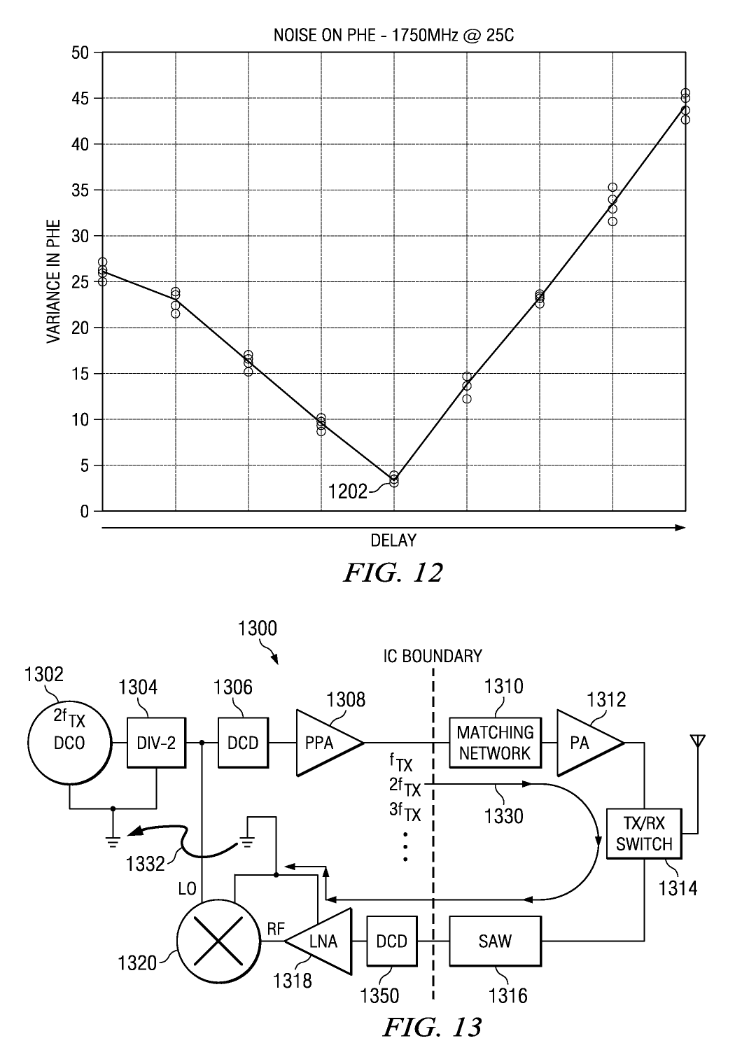

FIG. 12 is a plot illustrating variance in a phase error signal versus delay for different transmitted bursts. FIG. 12 captures root-mean-square value of five individual bursts transmitted at 1750 MHz that are shown as circles on the plot. The measurement is done across various round trip delays between the DCO and the PPA resulting from configuring that delay of DCD 1054. The optimum delay with respect to variance in PHE is indicated at 1202, which corresponds to the optimum delay with respect to EVM. The correlation between the average of root-mean-square value over 5 bursts in PHE and mean RMS EVM is essentially linear. The correlation factor of 0.8 is sufficient to carry out a reliable calibration operation.

This inverter-chain based solution may impose a risk to far-out phase noise at frequency offsets of 20 MHz from the carrier frequency since adding this circuitry in the main signal line will increase the thermal noise floor of the transmitter. If the contribution of DCO phase noise at 20 MHz is 10 dB more than the thermal noise floor of the system with the highest number of inverter stages engaged, then the overall effect on phase noise due to the DCD circuit will be insignificant.

FIG. 13 is a block diagram of a pulling mechanism in a GSM radio that may be mitigated using a digitally controlled delay module. In this embodiment, use of a DCD to change the phase of the aggressor signal returning to the DCO can be extended as a solution to other issues as well where the coupling mechanism is slightly different. In this case, the PPA 1308 generates a signal at 0 dBm output power that is amplified by PA 1312 to 30 dBm. Due to marginal isolation between the transmit and receive port of switch 1314, a significant level of RF signal leaks back 1330 into the receiver and interferes with the DCO 1302 ground 1332. The effect of this impairment on the system performance is the excessive peak phase trajectory error that is suffered at the start of the burst during PA power ramp. The magnitude of interferer can be reduced by increasing the isolation between the transmit and receive ports of the front end switch 1314 or increasing the isolation between the receiver input and the DCO 1302 ground. However, another solution is to adjust with DCD 1306 the phase of the interferer arriving at the DCO to reduce the extent of damage.

### System Example

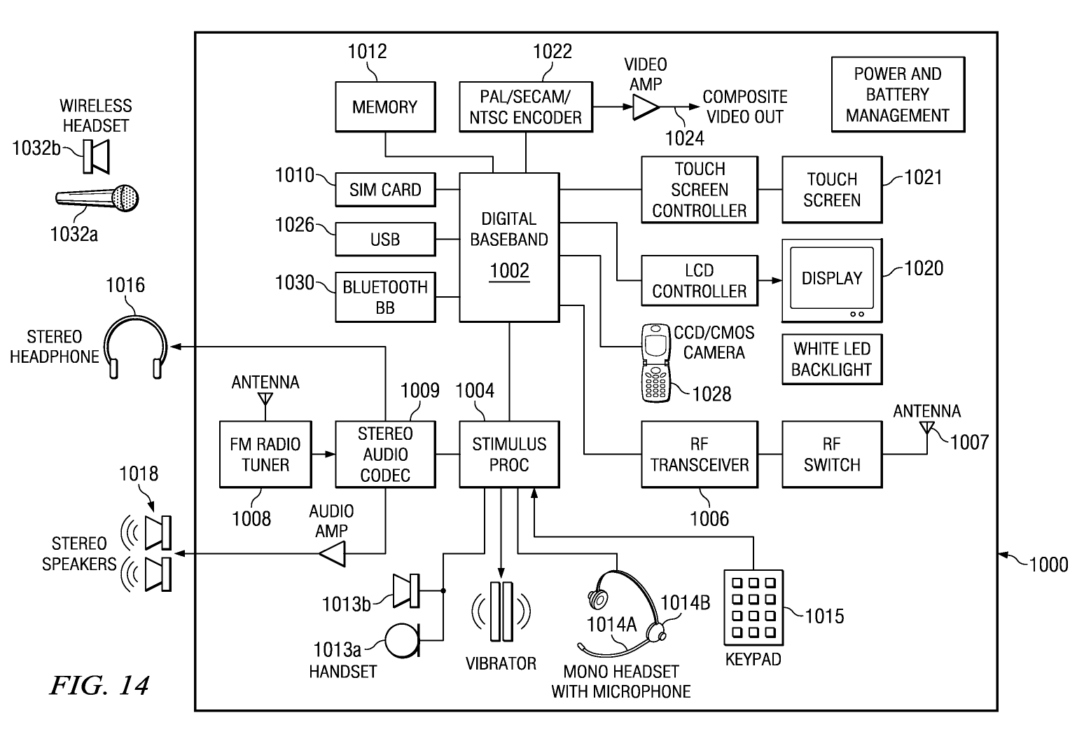

FIG. 14 is a block diagram of mobile cellular phone 1000 for use in the network of FIG. 1. Digital baseband (DBB) unit 1002 can include a digital processing processor system (DSP) that includes embedded memory and security features. Stimulus Processing (SP) unit 1004 receives a voice data stream from handset microphone 1013a and sends a voice data stream to handset mono speaker 1013b. SP unit 1004 also receives a voice data stream from microphone 1014a and sends a voice data stream to mono headset 1014b. Usually, SP and DBB are separate ICs. In most embodiments, SP does not embed a programmable processor core, but performs processing based on configuration of audio paths, filters, gains, etc being setup by software running on the DBB. In an alternate embodiment, SP processing is performed on the same processor that performs DBB processing. In another embodiment, a separate DSP or other type of processor performs SP processing.

In this embodiment, the digital baseband processing is included in a single integrated circuit chip with the transceiver in the form of a DRPe as a system on a chip (SOC). RF transceiver 1106 is a digital radio processor and includes a receiver for receiving a stream of coded data frames from a cellular base station via antenna 1107 and a transmitter for transmitting a stream of coded data frames to the cellular base station via antenna 1107. At the heart of transceiver 1106 lies a digitally controlled oscillator (DCO), which deliberately avoids any analog tuning controls. Fine frequency resolution is achieved through high-speed dithering of its varactors. Digital logic built around the DCO realizes an interpolative all-digital PLL (ADPLL) that is used as a local oscillator for both the transmitter and receiver and operates as described above. The polar transmitter architecture utilizes the wideband direct frequency modulation capability of the ADPLL and a digitally controlled power amplifier (DPA) for the power ramp and amplitude modulation. In this embodiment, a single transceiver supports both GSM and WCDMA operation but other embodiments may use multiple transceivers for different transmission standards. Other embodiments may have transceivers for a later developed transmission standard with appropriate configuration. RF transceiver 1106 is connected to DBB 1102 which provides processing of the frames of encoded data being received and transmitted by cell phone 1100.

The basic WCDMA DSP radio consists of control and data channels, rake energy correlations, path selection, rake decoding, and radio feedback. Interference estimation and path selection is performed by instructions stored in memory 1112 and executed by DBB 1102 in response to signals received by transceiver 1106. Programmable features of the ADPLL within transceiver 1106 are controlled by instructions executed by DBB 1102.

Embodiments of the present invention minimize signal quality degradation incurred due to pulling of the oscillator by noise or ground bounce caused by transients in amplitude modulation. In the current embodiment of the ADPLL architecture, which is strictly optimized for low area and power consumption, maintaining an excessive ADPLL bandwidth all the time in order to manage noise induced oscillator pulling would degrade spectral mask by less filtering of the reference and TDC (time to digital converter) phase noise. An adjustable phase delay is provided between the DCO and the PPA, as described in more detail above. In one embodiment, the adjustable phase delay is provided through a string of inverters. The delay may be calibrated using a phase error (PHE) signal from a phase detector in the ADPLL that forms the DCO. The PHE signal is sensitive to the extent of parasitic modulation suffered by the DCO as a result of pulling; hence the variance of this signal can be used to sense the extent of pulling and calibrate for optimum delay. In one embodiment, this delay is calibrated in the center of the Digital Cellular System (DCS1800) and Personal Cellular System (PCS1900) band. Temperature compensation is performed according to a well characterized empirical formula.

DBB unit 1002 may send or receive data to various devices connected to universal serial bus (USB) port 1026. DBB 1002 can be connected to subscriber identity module (SIM) card 1010 and stores and retrieves information used for making calls via the cellular system. DBB 1002 can also connected to memory 1012 that augments the onboard memory and is used for various processing needs. DBB 1002 can be connected to Bluetooth baseband unit 1030 for wireless connection to a microphone 1032a and headset 1032b for sending and receiving voice data. DBB 1002 can also be connected to display 1020 and can send information to it for interaction with a user of the mobile UE 1000 during a call process. Display 1020 may also display pictures received from the network, from a local camera 1026, or from other sources such as USB 1026. DBB 1002 may also send a video stream to display 1020 that is received from various sources such as the cellular network via RF transceiver 1006 or camera 1026. DBB 1002 may also send a video stream to an external video display unit via encoder 1022 over composite output terminal 1024. Encoder unit 1022 can provide encoding according to PAL/SECAM/NTSC video standards. In some embodiments, audio codec 1109 receives an audio stream from FM Radio tuner 1108 and sends an audio stream to stereo headset 1116 and/or stereo speakers 1118. In other embodiments, there may be other sources of an audio stream, such a compact disc (CD) player, a solid state memory module, etc

### Other Embodiments

While the invention has been described with reference to illustrative embodiments, this description is not intended to be construed in a limiting sense. Various other embodiments of the invention will be apparent to persons skilled in the art upon reference to this description. This invention applies to all scheduled communication systems which use oscillators that may suffer on-frequency variable interference originating from other circuits in the system. This invention applies in uplink and downlink. Various embodiments of this invention apply for many modulation strategies, which include but are not limited to, OFDMA, CDMA, DFT-spread FDMA, SC-OFDMA, and others. Embodiments of this invention can be applied in most if not all emerging wireless standards, including EUTRA.

In another embodiment, the DCD may be embodied using other delay means, such as a controllable capacitor network, a variable resistor-capacitor network, a string of non-inverting buffers, etc. In another embodiment, the delay elements may be configured in more than one chain. In another embodiment, the delay elements may have differing values of individual delay.

In some embodiments, the error signal may be filtered, for example through digital processing, to isolate the component that relates to the interference caused by the aggressor of interest, typically the amplitude-modulated harmonic in the DPA and/or transmitter output. Using a square wave calibration signal is one way to do this. When the interference is strong, such that the noise and other contributors are insignificant, then a simple RMS calculation, without filtering, may be sufficient.

In other embodiments, there is no need to filter the RF harmonic of interest. It is always ‘filtered’ or selected naturally, since it is at the same frequency the RF oscillator is running at and therefore only it can aggress it. For example, when a divide-by-2 is placed between the oscillator and the rest of the TX path, then it is the second harmonic of the output signal that falls exactly on the frequency of oscillation and can therefore aggress it, while the 3^{rd} harmonic and the fundamental are distant from the oscillation frequency.

In other embodiments, the oscillator frequency may be undivided, divided by two, divided by three, etc. An aggressing signal frequency will depend on the amount of frequency division.

In another embodiment of the invention, the phase error signal is monitored during normal operation and the delay setting of the programmable delay module is continuously adjusted for optimal interference-mitigation in a closed-loop manner instead of the open-loop manner. This would be particularly useful in continuous transmission rather than packetized, such as in WCDMA.

While a mobile user equipment device has been described, embodiments of the invention are not limited to mobile devices. Desktop equipment and other stationary equipment being served by a cellular network may also embody an ADPLL as described herein with a configurable delay between the DCO and another circuit module. NodeB's in a network may also use embodiments of the present invention in transmitters used to communicate with UEs.

Although the invention finds particular application to systems using Digital Signal Processors (DSPs), implemented, for example, in an Application Specific Integrated Circuit (ASIC), it also finds application to other forms of processors. An ASIC may contain one or more megacells which each include custom designed functional circuits combined with pre-designed functional circuits provided by a design library.

An embodiment of the invention may include a system with a processor coupled to a computer readable medium in which a software program is stored that contains instructions that when executed by the processor perform the functions of modules and circuits described herein. The computer readable medium may be memory storage such as dynamic random access memory (DRAM), static RAM (SRAM), read only memory (ROM), Programmable ROM (PROM), erasable PROM (EPROM) or other similar types of memory. The computer readable media may also be in the form of magnetic, optical, semiconductor or other types of discs or other portable memory devices that can be used to distribute the software for downloading to a system for execution by a processor. The computer readable media may also be in the form of magnetic, optical, semiconductor or other types of disc unit coupled to a system that can store the software for downloading or for direct execution by a processor.

As used herein, the terms “applied,” “connected,” and “connection” mean electrically connected, including where additional elements may be in the electrical connection path. “Associated” means a controlling relationship, such as a memory resource that is controlled by an associated port. The terms assert, assertion, de-assert, de-assertion, negate and negation are used to avoid confusion when dealing with a mixture of active high and active low signals. Assert and assertion are used to indicate that a signal is rendered active, or logically true. De-assert, de-assertion, negate, and negation are used to indicate that a signal is rendered inactive, or logically false.

It is therefore contemplated that the appended claims will cover any such modifications of the embodiments as fall within the true scope and spirit of the invention.

What is claimed is:

1. A system comprising a transmitter with a built-in self-interference mitigation mechanism, wherein the transmitter comprises:
a radio frequency (RF) oscillator operable to generate an RF signal;
a phase detector coupled to the frequency oscillator operable to detect a phase error between the RF signal and a reference frequency signal and to output a corresponding phase error signal;
a variable delay module coupled to receive the RF signal and operable to output a delayed RF signal that is delayed by a configurable time delay amount;
a power amplifier coupled to receive the delayed RF signal being operable to produce an amplified delayed RF signal: and
a control module coupled to the variable delay module, wherein the control module is configured in a calibration mode to determine an optimal amount of delay for use in configuring the variable delay module to force between an aggressing RF signal from the transmitter and the RF signal, whereby frequency or phase perturbations inflicted by the transmitter's signal to the RF oscillator may be minimized.

2. The system of claim 1, wherein the control module is coupled to receive the phase error signal reflecting the extent of interference that is experienced in the RF oscillator, the control module being operable in a calibration mode to vary the time delay amount over a range of delay, to determine an optimal delay setting for which minimal interference is experienced over the range of delay, and to configure the variable delay module to said optimal delay setting during the transmitter's normal operation.

3. The system of claim 1, wherein the frequency oscillator is a digitally controlled phase locked loop, and wherein the phase error signal is a digital signal.

4. The system of claim 2, wherein the power amplifier comprises an amplitude modulation module coupled to receive an amplitude signal, and operable to amplitude-modulate the delayed RF signal in accordance with the amplitude signal.

5. The system of claim 4, wherein the control module is operable to provide a predefined calibration amplitude signal to the amplitude modulation module for use during the calibration mode.

6. The system of claim 1, wherein the control module is further operable to periodically adjust the time delay amount by a predetermined amount according to a present temperature of the transmitter.

7. The system of claim 1, wherein the variable delay module comprises a serially connected chain of delay elements and a configurable selection module coupled to a plurality of tap points in the chain of delay elements, wherein an output of the selection module provides the delayed RF signal.

8. The system of claim 7, wherein the chain of delay elements is operable to delay the RF signal by a delay amount greater than or equal to one quarter of a period of an aggressor RF signal that aggresses the RF oscillator.

9. The system of claim 8, wherein the aggressor RF signal is a harmonic of the delayed RF signal.

10. The system of claim 1 being a cellular handset, wherein an output of the power amplifier is coupled to an antenna.

11. A method for mitigating self-interference induced onto an oscillator in a transmitter comprising:
determining an optimal amount of delay to be forced between an aggressing RF signal and a victim RF signal in a victim circuit; and
delaying the aggressing RF signal by a configurable time delay amount that is substantially said optimal amount.

12. The method of claim 11, wherein the amount of delay comprises an amount of phase shift.

13. The method of claim 11, wherein determining an optimal amount of delay comprises calibrating the time delay amount by:
detecting a phase error between the aggressing RF signal and a reference frequency signal to form a phase error signal;
varying the time delay amount over a range of delay;
determining an extent of interference caused to the victim circuit by processing the phase error signal over the range of delay, and
recording an optimal delay setting for which the interference is minimal and the interfered performance is optimal, to be used in the normal mode of operation.

14. The method of claim 13, wherein calibrating further comprises filtering the error signal to isolate a component created by the aggressing RF signal.

15. The method of claim 13, wherein processing the phase error signal comprises calculating a variance of the phase error signal and associating the optimal delay setting with a lowest variance amount, whereby the strongest interference level would be associated with the highest variance.

16. The method of claim 13 wherein the range of delay is greater than or equal to one quarter of a period of a harmonic of the victim RF signal.

17. The method of claim 16, wherein the frequency of the delayed RF signal is approximately 4 GHz, the period of the delayed RF signal is approximately 0.5 ns and the range of delay is 0.0 to greater than or equal to 0.2 ns.

18. The method of claim 13 wherein the delayed RF signal is amplitude modulated during calibration by a predefined calibration amplitude signal.

19. The method of claim 13, wherein detecting a phase error indicates an extent of amplitude modulation to frequency modulation occurring while generating the amplitude-modulated RF signal due to parasitic coupling between the delayed RF signal and the victimized RF signal within the transmitter's RF oscillator.

20. The method of claim 11, further comprising:
determining a present temperature of the transmitter; and
periodically readjusting the time delay amount by a predetermined amount according to the present temperature.

21. A method for operating a transmitter in a system, comprising:
generating a radio frequency (RF) signal;
detecting a phase error between the RF signal and a reference frequency signal to form a phase error signal;
delaying the RF signal by a configurable time delay amount; and
amplitude modulating and amplifying the delayed RF signal for transmission; and
wherein an optimal time delay amount is determined during a calibration mode of operation by:
amplitude modulating the delayed RF signal by a predetermined calibration amplitude signal;
varying the time delay amount over a range of delay;
determining an extent of self-interference within the transmitter induced in the RF signal by processing the phase error signal over the range of delay, and
recording a delay setting for which the interference is minimal and the interfered performance is optimal, to be used in a normal mode of operation, whereby frequency or phase perturbations inflicted by the transmitter's signal to its RF oscillator may be minimized.
